(19) United States
(12) Patent Application Publication
(10) Pub. No.: US 2015/0201236 A1
(43) Pub. Date: Jul. 16, 2015

(54) Display Proximity Control Device

(71) Applicant: Khalifa Al Remeithi, Abu Dhabi (AE)

(72) Inventor: Khalifa Al Remeithi, Abu Dhabi (AE)

(21) Appl. No.: 14/155,785

(22) Filed: Jan. 15, 2014

(51) Int. Cl. H04N 21/442; H04N 5/44

(52) U.S. Cl. CPC H04N 21/44218; H04N 5/4403

(57) ABSTRACT

A display proximity control device, includes a micro-controller; a range finder connected to the micro-controller, the range finder configured to detect an individual and provide a distance range signal to the micro-controller; a video input configured to receive a video input signal and provide the video input signal to the micro-controller; and a video output configured to receive an output video signal from the micro-controller and output the output video signal. The micro-controller is configured to determine whether the individual is within a predetermined distance of the display proximity device and, if the individual is within the predetermined distance, interrupt a video input signal, and output the customizable message as the video output signal.

### BACKGROUND

1. Technical Field

The present disclosure is directed towards a device that provides a safeguard against watching a video display too closely, which can lead to eye strain and fatigue.

2. Description of the Related Art

Viewing televisions and displays at close distances for prolonged periods of time are known to cause eye strain, myopia, and other vision related medical issues. While devices for detecting the viewing distance of a television screen have been available, these devices are deficient in that they fail to provide sufficient warnings or provide customizable features to users. Accordingly, there is a need for a display proximity control device that is capable of detecting and warning an individual that is too close to the display. Additionally, there is a need for a display proximity control device that is customizable, expandable, and capable of communicating wirelessly with mobile devices and computers.

### BRIEF SUMMARY

An aspect of the present subject matter is directed to a display proximity control device, comprising: a micro-controller; a range finder connected to the micro-controller, the range finder configured to detect an individual and provide a distance range signal to the micro-controller; a video input configured to receive a video input signal and provide the video input signal to the micro-controller; and a video output configured to receive an output video signal from the micro-controller and output the output video signal; wherein the micro-controller is configured to determine whether the individual is within a predetermined distance of the display proximity device and, if the individual is within the predetermined distance, interrupt a video input signal, and output the customizable message as the video output signal.

Another aspect of the present subject matter is directed to a method of controlling a display based on viewer proximity, the method comprising: inputting an input video signal to a micro-controller of a display proximity control device; scanning an area in proximity to a display and generating a range signal using a range finder; outputting the range signal from the range finder to the micro-controller; determining, by the micro-controller, whether an individual is within a predetermined distance of the proximity control device; interrupting the input video signal if the individual is within the predetermined distance; and outputting a customizable video output signal.

### BRIEF DESCRIPTION OF THE DRAWINGS

Many aspects of the disclosure can be better understood with reference to the following drawings, wherein:

FIG. 1 shows a non-limiting exemplary embodiment of a display proximity control device implemented with a video display;

FIG. 2 is a top plan view thereof, showing ultrasonic waves used to detect a distance of an individual in front of the video display;

FIG. 3 is a front view of the display proximity control device;

FIG. 4 is a rear view of the display proximity control device, showing the connections thereof;

FIG. 5 is a top view of the display proximity control device, showing internal components thereof;

FIG. 6 is a non-limiting exemplary schematic of the display proximity control device;

FIGS. 7A-C show a display proximity control device that optionally includes tamper resistant video input and output connections; and

FIG. 8 is a flow chart showing a non-limiting exemplary embodiment of a method of controlling a display based on viewer proximity.

### DETAILED DESCRIPTION OF THE SUBJECT MATTER

Reference is now made in detail to the description of non-limiting embodiments as illustrated in the drawings. While the embodiments described may use specific components or configurations, there is no intent to limit the subject matter to the embodiment or embodiments disclosed herein. Accordingly, various modifications to the embodiments presented may be readily apparent to those skilled in the art, and the generic principles described herein can be applied to other non-limiting embodiments without departing from the spirit or scope of the claimed subject matter. As such, this detailed description of various alternative embodiments should not be construed to limit the scope or breadth of the present apparatus, system and method as set forth in the claims.

In a non-limiting exemplary embodiment, the presently disclosed device may be used between a video source and a display, such as a television or computer monitor. The video source feeds the device with video signals, which are passed through the device, to the display. The device may be positioned near the display, facing an individual or an audience. The device scans the area in front of the device for individuals and nearby objects using, for example, an ultrasonic sensor or range finder contained within the device. A distance of the individuals is determined and information from the range finder is provided to a micro-controller also contained within the device. The scanning may be an ongoing process, and if any object, individual or viewer is found within a predetermined distance from the device, the micro-controller will interrupt the video input from the video source, and output a customizable message or video signal as the video output. By way of a non-limiting example, the customizable message may be a warning, such as “Please Move Back” in white letters on a black screen. Once the individual moves to a safe viewing distance, the micro-controller resumes supplying the original video input to the video output. However, the customizable message or video signal can be any such warning or alert to the individual or individuals within the predetermined distance to the device, and ti should be recognized that the customizable message is intended to include numerous combinations of colors, text, pictures, warnings, sounds, video, etc.

The micro-controller within the device can be programmed and reprogrammed using, for example, a computer or mobile device. Accordingly, updates and upgrades can be provided. For example, additional sensors can be added for sensing room temperature, humidity, gas, motion, etc. The device may be configured to easily integrate additional sensors and provide additional information on the display. Further, the device optionally provides wireless capabilities such that the device can connect to the internet. In such an exemplary embodiment, the device is capable of connecting to the internet and fetching, for example, RSS feeds from news agencies or blogs or other social network sites, and overlay the information into the video input so that the RSS feed is outputted with the video output. Additional features of the device include support for web browsing and emailing.

By way of non-limiting example, the micro-controller may be a high-performance Atmel 8-bit AVR RISC-based micro-controller. This particular micro-controller combines 32 KB ISP flash memory with read-while-write capabilities, 1 KB EEPROM, 2 KB SRAM, 23 general purpose I/O lines, 32 general purpose working registers, three flexible timer/counters with compare modes, internal and external interrupts, serial programmable USART, a byte-oriented 2-wire serial interface, SPI serial port, 6-channel 10-bit A/D converter (8-channels in TQFP and QFN/MLF packages), programmable watchdog timer with internal oscillator, and five software selectable power saving modes. It should be recognized that numerous programmable micro-controllers are available and that a person having ordinary skill in this art would be capable of selecting an appropriate micro-controller based on the present disclosure.

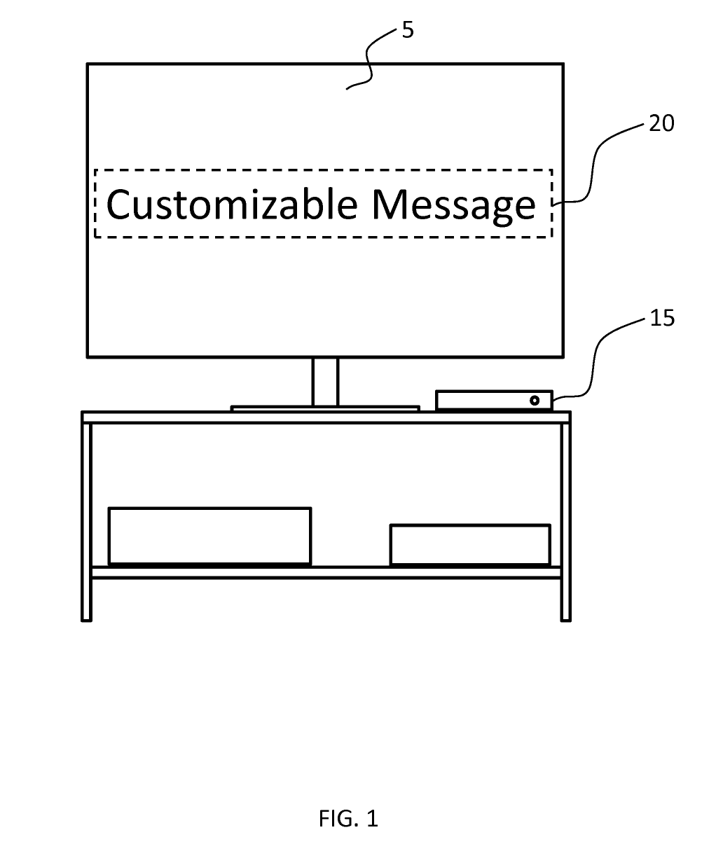

Reference is now made to the non-limiting exemplary embodiment of a display proximity control device as shown in FIGS. 1-6. Shown in FIG. 1 is a display proximity control device 15 implemented with a display 5. Shown on display 5 is a “Customizable Message” 20 generated by display proximity control device 15 in the event that an individual is too close to the display. The “Customizable Message” 20 may be configured to include numerous combinations of colors, text, pictures, warnings, sounds, video, etc.

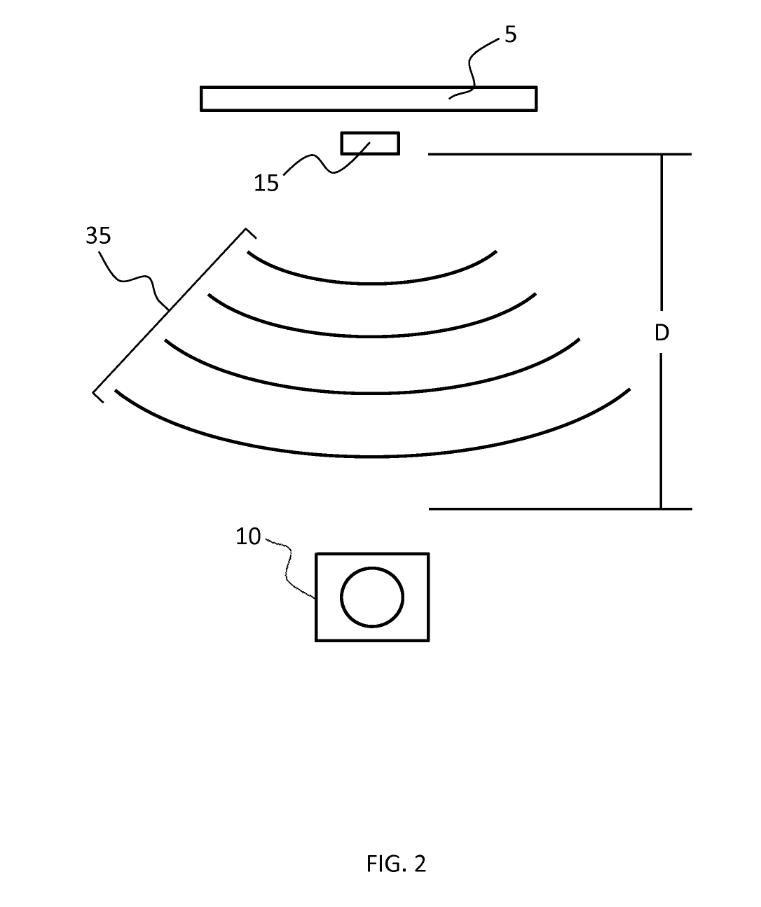

Shown in FIG. 2 is a top plan view of display proximity control device 15 implemented with display 5 from the non-limiting example of FIG. 1. Display proximity device 15 transmits, for example, ultrasonic waves 35 that are used to detect and determine a distance of an individual 10 in front of the display 5. A predetermined distance D is used by display proximity control device 15 as a safe viewing distance. Predetermined distance D can be determined using various data regarding safe viewing distance. By way of non-limiting example, a minimum recommended viewing distance for a 19 inch (47 cm) television is 95 cm, and for a 43 inch (109 cm), a minimum recommended viewing distance 200 cm. Accordingly, the predetermined distance D can be selected to an appropriate distance in accordance with the television or display size.

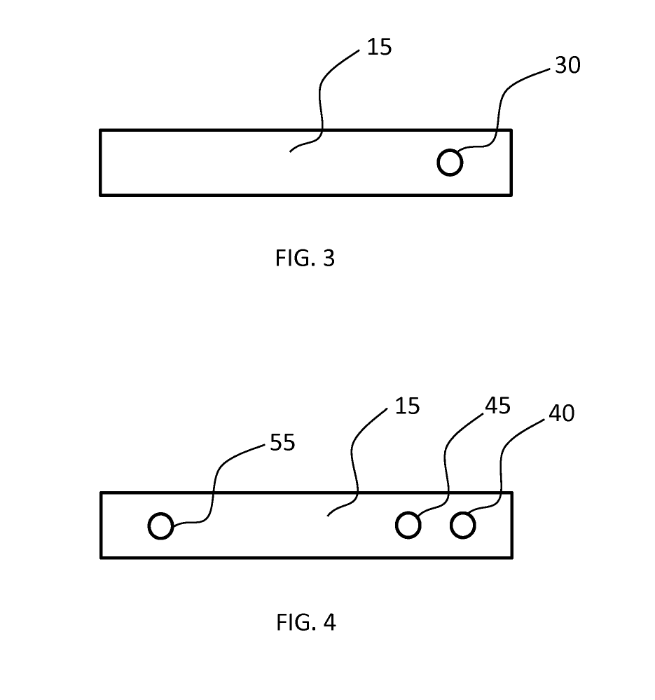

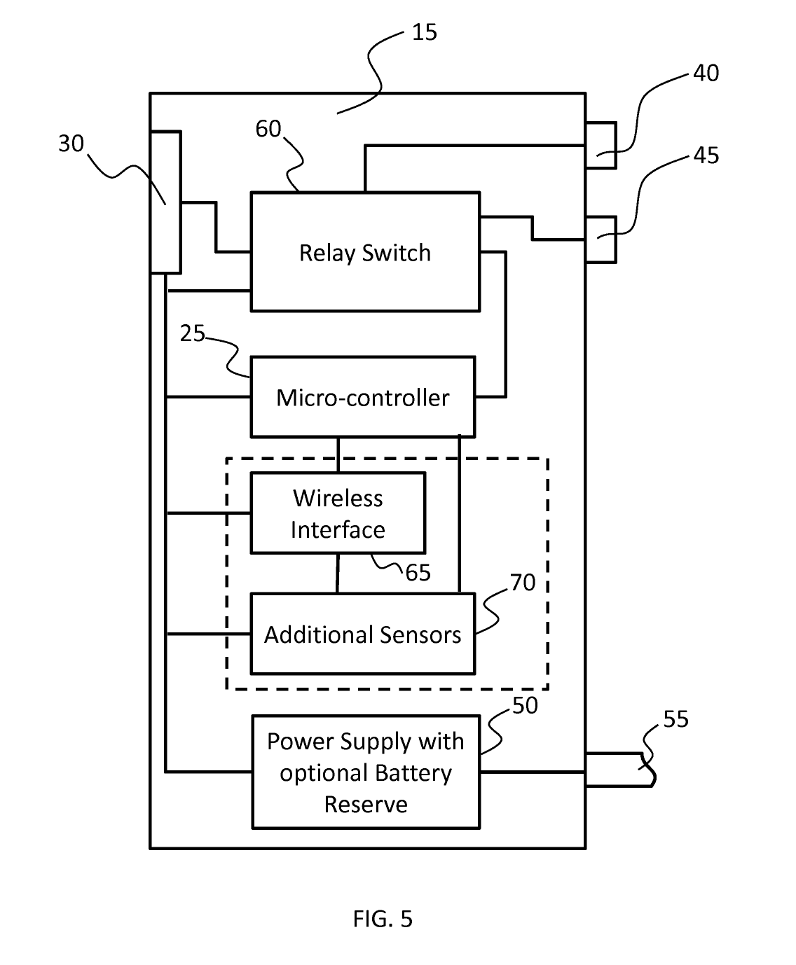

FIGS. 3 and 4 are front and rear views, respectively, of display proximity control device 15 from the non-limiting embodiment depicted in FIG. 1. Shown in FIG. 3 on the front side of display proximity control device 15 is a range finder 30, or similar device for detecting distance or motion using, for example, sound waves 35 as appearing in FIG. 2. On the rear side of display proximity control device 15 are various connections, including a video input 40, a video output 45 and a power input 55. Connections for video input 40 and video output 45 may be any one of the various available signal standards, including, but not limited to, High-Definition Multimedia Interface (HDMI), RCA, composite video, component video, coaxial cable, S-Video, Digital Visual Interface (DVI), Apple® Thunderbolt® hardware interface, and numerous other technologies that support video signals.

Additionally, display proximity control device 15 may further comprise a universal serial bus (USB), mini-USB or other connector capable of connecting a computer. Furthermore, provisions for a secure digital (SD) card or other non-volatile memory card or device may further be included in display proximity control device 15.

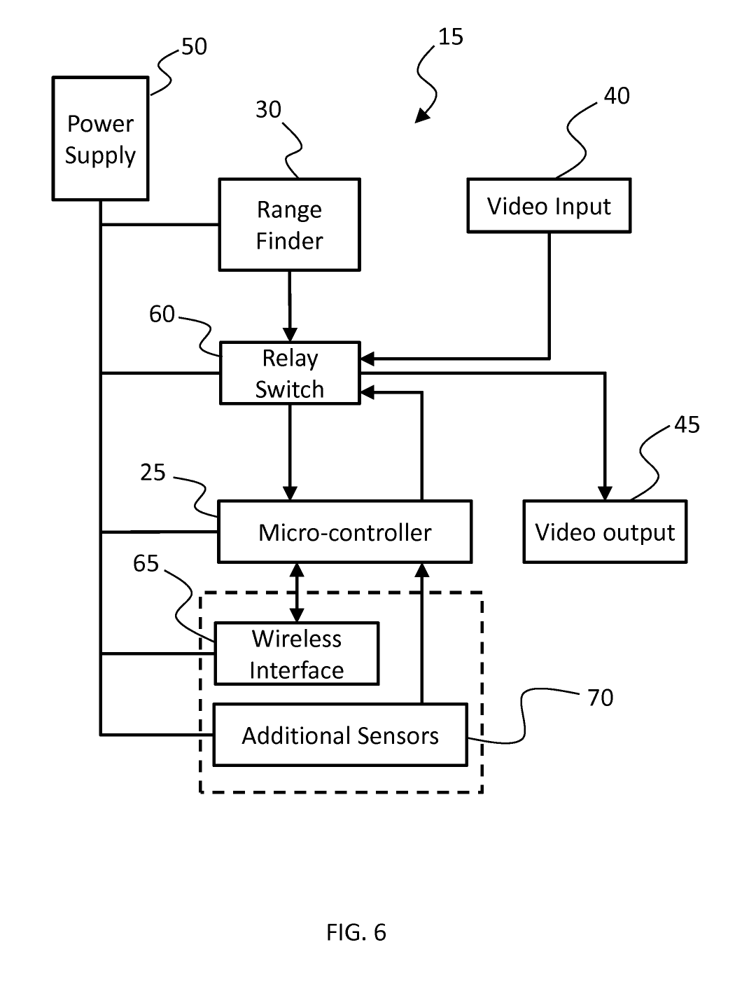

Shown in FIG. 5 is a top view showing internal components of a non-limiting exemplary embodiment of display proximity control device 15. A power supply 50, receiving power from power input 55 is connected to the internal components of display proximity control device. Video input 40 and range finder 30 are connected to a relay switch 60, which channels electronic signals and electric signals to a micro-controller 25. Also shown are additional sensors 70 that may be added for sensing, for example, room temperature, humidity, gas, motion, etc. Display proximity control device 15 is configured to easily integrate additional sensors 70 and provide additional information overlaid on the video source on display 5.

Additionally, power supply 50 may optionally include a battery reserve, which may be an internal rechargeable battery with long operational lifetime or a replaceable battery. Various battery types and sizes according to various standards established by, for example, the International Electrotechnical Commission (IEC) and American National Standards Institute (ANSI) may be employed as part of, or in conjunction with, power supply 50.

Optionally included is a wireless interface 65 that allows for wireless functionality as previously described. Wireless interface 65 also provides the capability to program and reprogram micro-controller 25 wirelessly using a computer or mobile device. Various wireless application protocols and components may be used for wireless interface 65. For example, a GSM mobile shield, a Wi-Fi shield, or other suitable components or protocols may be employed.

Additionally, micro-controller 25 may also be configured to send and receive messages from a mobile device via wireless interface 65. In such an embodiment the mobile device may configured to control micro-controller 25, for example, by sending command messages. The command messages may include displaying a personalized message as the customizable video output signal or interrupting the video input signal. Various messaging formats may be used, for example email, text message, short message service (SMS), multimedia message service (MMS), or other messaging method. Micro-controller 25 may be further configured to record activity of display proximity control device, generate a device activity report, and send the device activity report to an external mobile device or computer. Additionally micro-controller 25 may be configured to be controlled by smart devices or computers.

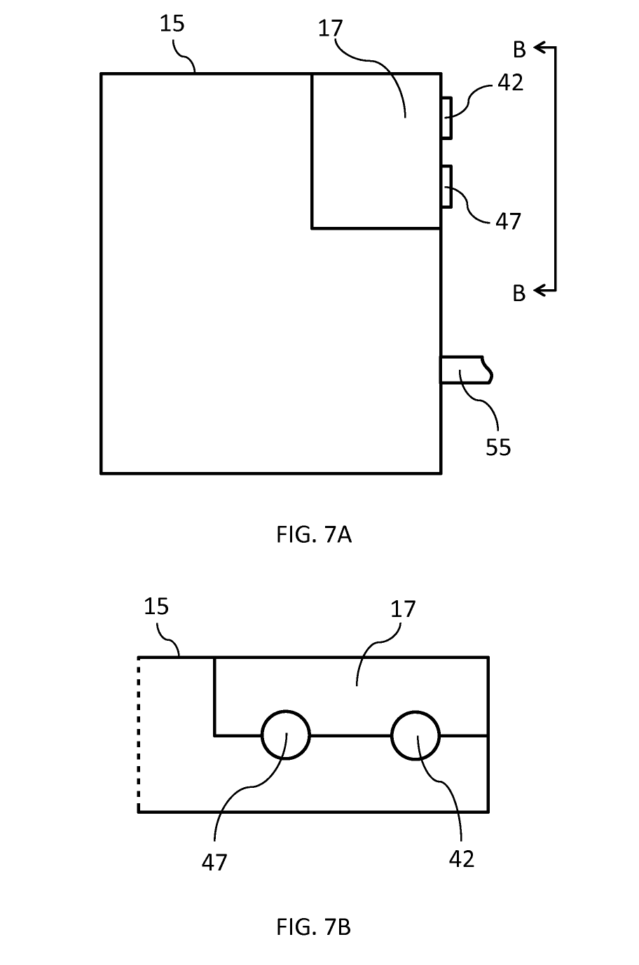

Shown in FIG. 6 is a non-limiting exemplary embodiment of a schematic of display proximity control device 15. Range finder 30 transmits sound waves 35 (see FIG. 2) which bounce off of an individual 10 in front of display 5 and return to range finder 30 of display proximity control device 15. Based on the time it takes returning sound waves to return, range finder 30 can determine the distance of individual 10. Alternatively, range finder 30 can provide a continuous range signal to micro-controller 25, which can process the continuous range signal to determine the distance of individual 10.

Through video input 40, a video signal is channeled through relay switch 60 to micro-controller 25. When a determination has been made that no individual is within a predetermined distance D, micro-controller outputs video input 40 through relay switch 60 to video output 45 without interruption. However, if a determination is made that an individual 10 is within predetermined distance D, micro-controller 25 will interrupt a video input signal, and output the customizable message as the video output signal to video output 45. Optionally shown in FIG. 6 are wireless interface 65 and additional sensor 70, both of which are connected to micro-controller 25 to provide additional functionality.

Display proximity control device 15 may be further configured to provide numerous additional features, including, but not limited to, the following non-limiting exemplary features: tamper notification, video still capture and content monitoring, motion detection security, a panic button, person-to-person communication, and gesture control.

By way of non-limiting exemplary embodiment, display proximity control system 15 may be configured to send an SMS message or email notification to a mobile device or computer, thus notifying an individual that display proximity control device 15 has been tampered with, disconnected, or otherwise disabled. In such an embodiment, when display proximity control device is disconnected, including a power failure, the general packet radio service (GPRS) may be operable from the optionally provided reserve battery discussed above. GPRS is a packet oriented mobile data service on the 2G and 3G cellular communication system's global system for mobile communications (GSM). Alternatively, newly developed or developing mobile technologies, such as 4G, may also be used.

Video Still and Content Monitoring: according to the various non-limiting exemplary embodiments, display proximity control device 15 may be adapted to capture information, video stills, or video segments from the video source. Captured information may be stored in a SD-Card or other non-volatile memory that is removable or internally included within display proximity control device 15. A parent, employer, or other individual may monitor the content and duration of material viewed on display 5, regardless to video or data source. This monitoring capability may include, but not limited to, video games played, videos played, websites visited, and messages sent and received. The duration of use may also be monitored.

The captured information may be accessed directly on the screen as an activity log, downloaded using a USB or similar cable, viewed using any personal computer or smart device using web interface module, or retrieved by removing the SD card from display proximity control device 15. Additionally, the operating system of display proximity control device 15 may be connected to local network (LAN) using, for example, a built in HTTP server which can provide web services like browsing file contents. Other capabilities include, but not limited to, are control of display 5, via display proximity control device 15, by scheduling operational availability, broadcasting screen messages and alerts, and sending emails, notifications, or other messages.

Furthermore, an individual can monitor real-time system usage, and find out what is playing on the screen. Video output 45 to display 5 can be interrupted immediately and remotely using any web enabled device, such as smart phones or computers. Additionally, customizable message 20 or other communication can be displayed or broadcast on display 5.

Person-to-person communication: by way of non-limiting example, display proximity control device 15 may be configured for person-to-person communication, as well as to remotely operate the system. For example, an SMS message may be displayed on display 5 as customizable message 20. As such, a parent, for example, may send an SMS message such as “Do Your Math Homework.” Additionally, display proximity control device 15 may be configured to display a predetermined message at a predetermined time or after a predetermined viewing duration.

Display proximity control device 15 may further include interactive response, based on game controllers, which include multiple control buttons. By way of non-limiting example, using mobile device with an installed application, a parent may interact with a child playing a video game by sending a message, such as “Do You Want Pizza for Dinner ?” Using the game controller, the child can respond back by pressing a predefined button on the game controller as to indicate “Yes” or “No.” This response will be sent back to the parent as an SMS message. These additional communication features could be further tamper proofed by ensuring that only authorized or recognized mobile devices or mobile numbers are able to communicate with display proximity control device 15.

Gesture control and interactivity may optionally be included with display proximity control device 15, such that the system is compatible with, for example, Microsoft® Kinect® systems, such that display proximity control device 15 is capable of general control of display 5, including volume and channel control, as well as other typical commands controlled by gestures. These features are obtain be employing infrared signals used by the Kinect® system to control various functions of display 5.

In addition to the above use based features, display proximity control device 15 may be configured with various security features. By way of non-limiting example, display proximity control device 15 may be employed as a motion detector security system. Such a system could be activated when upon leaving the home or place of business. When active, the system can detect physical movement. The system may be configured to turn on an alarm, transmit a noise, display an alert warning, send an SMS message, or otherwise communicate with the owner or law enforcement.

Additionally, display proximity control device 15 may incorporate an emergency alert or panic button, useful in the event of a home emergency, such as an illness, injury, fire, or home invasion. This feature may use GPRS wireless technology to send an instant SMS message to a parent, owner, predetermine mobile phones, law enforcement, or emergency services alerting them that there is an emergency. The emergency alert may be further configured to include preprogramed information, for example, an address, contact information, number and ages of individuals in the home, specific medical information, etc.

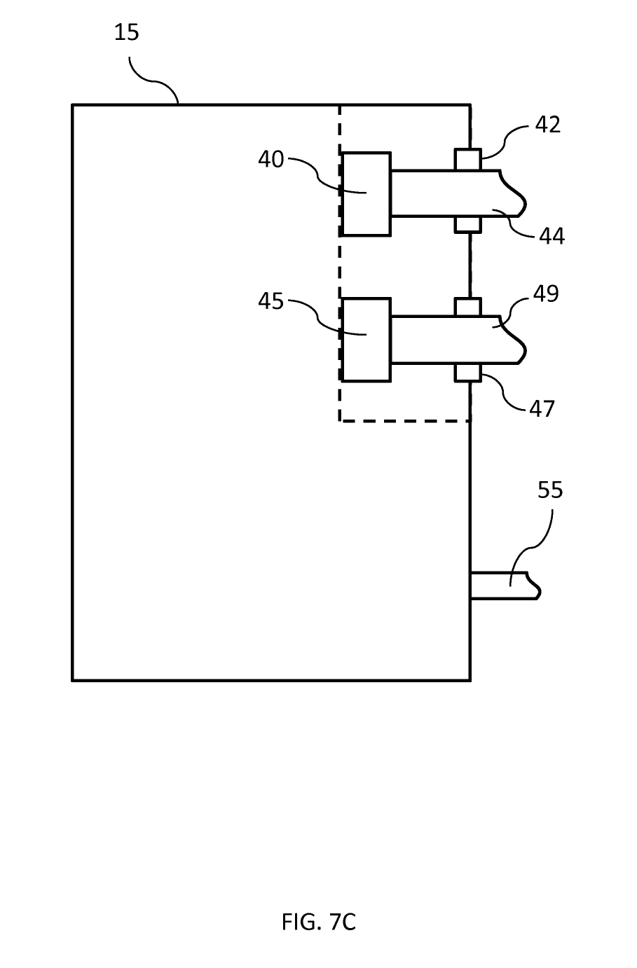

In order to prevent display proximity control device 15 from being tampered with or disabled, display proximity control device 15 may be optionally provided with various tamper resistant features. FIGS. 7A-C show a non-limiting exemplary embodiment of display proximity control device 15 that optionally includes connections for video input 40 and video output 45 that are located internally, underneath a secured cover 17. An input conduit 42 and an output conduit 47 are provided.

When secured cover 17 is removed (see e.g., FIG. 7C), internally located connections for input video 40 and output video 45 are accessible. An input cable 44 passes through input conduit 42 and an output cable 49 passes through output conduit 47. When secured cover 17 is replaced, the physical connections for video input 40 and video out 45 are internal, thus not accessible to be tampered with, disconnected, or otherwise disabled. Secured cover 17 may further include a locking mechanism or some other device that would prevent an unauthorized individual from obtaining access, or in the alternative, providing notice of unauthorized access.

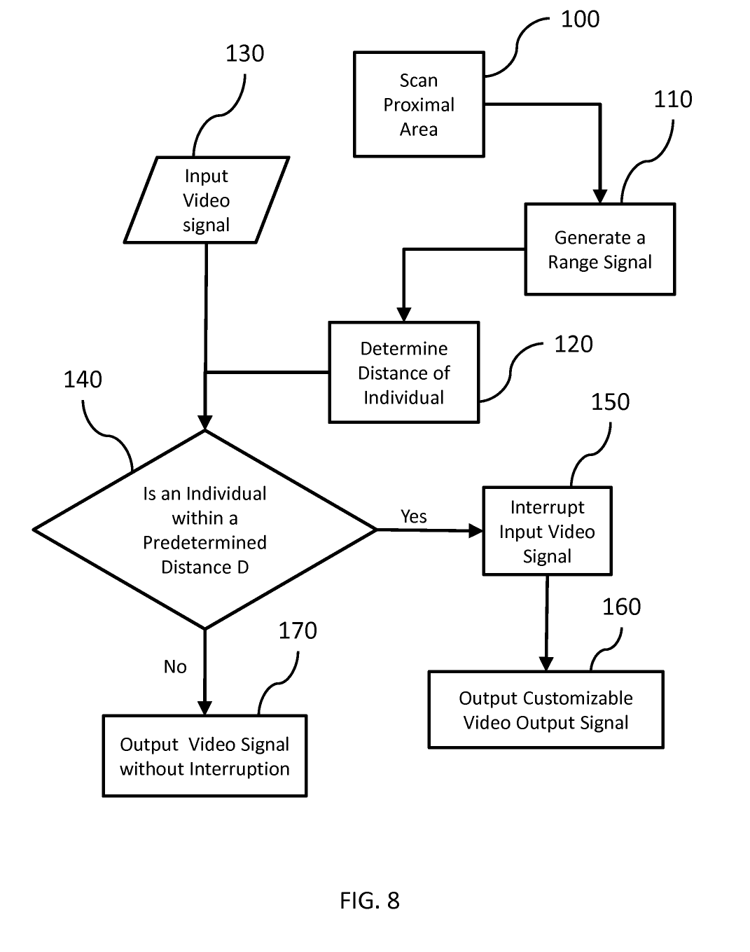

Shown in FIG. 8 is a non-limiting exemplary flowchart of a method of controlling display 5 based on viewer proximity. In step 100, the area in proximity to display proximity control device 15 and display 5 is scanned using range finder 30. In step 110, a range signal is generated and in step 120, the distance of any individuals 10 in front of display proximity control device 15 is determined. Concurrently, in step 130, a video signal is input into display proximity control device 15. In step 140, is determined whether an individual 10 is within a predetermined distance D of display proximity control device 15. In it is determined in step 140 that an individual 10 is within a predetermined distance D, in step 150, the video signal is interrupted. In step 160, a customizable video output signal is output to display 5. If it is determined in step 140 that no individual is within the predetermined distance D, the video signal is output to display 5 without interruption.

While the foregoing written description of the disclosure enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

1. A display proximity control device, comprising:
a micro-controller;
a range finder connected to the micro-controller, the range finder configured to detect an individual and provide a distance range signal to the micro-controller;
a video input configured to receive a video input signal and provide the video input signal to the micro-controller; and
a video output configured to receive an output video signal from the micro-controller and output the output video signal;
wherein the micro-controller is configured to determine whether the individual is within a predetermined distance of the display proximity device and, if the individual is within the predetermined distance, interrupt a video input signal, and output the customizable message as the video output signal.

2. The display proximity control device of claim 1, further comprising: at least one relay switch, wherein at least one of the range finder, the video input connector, and the video output connector are connected to the micro-controller through the at least one relay switch.

3. The display proximity control device of claim 1, further comprising a wireless interface connected to the micro-controller.

4. The display proximity control device of claim 3, wherein the wireless interface is selected from at least one of a GSM mobile shield and a Wi-Fi shield.

5. The display proximity control device of claim 3, wherein the micro-controller is configured to send and receive messages from a mobile device.

6. The display proximity control device of claim 5, wherein the mobile device is configured to control the micro-controller by sending command messages.

7. The display proximity control device of claim 6, wherein the command messages include displaying a personalized message as the customizable video output signal, and interrupting the video input signal.

8. The display proximity control device of claim 3, wherein the micro-controller is configured to be controlled by smart devices or computers.

9. The display proximity control device of claim 3, wherein the micro-controller is further configured to record device activity, generate a device activity report, and wirelessly send the device activity report to an external mobile device or computer.

10. The display proximity control device of claim 3, wherein the wireless interface is connected to the internet and the customizable message output as the video output signal comprises an information feed overlaid on the input video signal.

11. The display proximity control device of claim 10, wherein the information feed comprises RSS feeds, social networking updates, weather forecasts, alarms, and reminders.

12. The proximity control device of claim 1, further comprising at least one additional sensor connected to the micro-controller.

13. The proximity control device of claim 12, wherein the at least on additional sensor is selected from the group comprising a room temperature sensor, a humidity sensor, gas sensor, and a motion sensor.

14. The proximity control device of claim 1, further comprising a selectable switch to set the predetermined distance in relation to a size of a display.

15. The proximity control device of claim 3, wherein the micro-controller is further configured to detect device tampering.

16. The proximity control device of claim 15, where the micro-control device is further configured to send a tamper message to a mobile device or computer upon detection of the device tampering.

17. The proximity control device of claim 1, wherein the video input and the video output are located internally, beneath a secured cover.

18. The proximity control device of claim 1, wherein the customizable message is an emergency alert.

19. The proximity control device of claim 1, wherein the micro-controller is further configured to communicate with gesture controlled devices.

20. A method of controlling a display based on viewer proximity, the method comprising:
inputting an input video signal to a micro-controller of a display proximity control device;
scanning an area in proximity to a display and generating a range signal using a range finder;
outputting the range signal from the range finder to the micro-controller;
determining, by the micro-controller, whether a viewer is within a predetermined distance of the proximity control device;
interrupting the input video signal if the viewer is within the predetermined distance; and
outputting a customizable video output signal.
